(19) United States
(12) Patent Application Publication
(10) Pub. No.: US 2003/0201619 A1
(43) Pub. Date: Oct. 30, 2003

(54) Universal transportation wheel kit

(76) Inventors: Jimmy Teng, La Puente, CA (US); Johnathan Teng, La Puente, CA (US)

Correspondence Address: Raymond Y. Chan, Suite 128, 108 N. Ynez Avenue, Monterey Park, CA, 91754, US

(21) Appl. No.: 10/133,307

(22) Filed: Apr. 29, 2002

(51) Int. Cl. B62B 5/00

(52) U.S. Cl. 280/79.11

(57) ABSTRACT

A universal transportation wheel kit includes a plurality of universal wheel assemblies adapted for mounting on a heavy object to be transported thereon in a detachable manner, and a connecting device for securely connecting all the universal wheel assemblies. Each of the universal wheel assemblies includes a base and two retaining walls extended therefrom to define a retaining cavity for fittedly coupled with the one of the bottom corner portions of the object, so as to substantially support the object on the universal wheel assemblies in a movable manner. The connecting device comprises at least one elongated element, connected to each of the universal wheel assemblies to define a supporting boundary within the universal wheel assemblies.

### BACKGROUND OF THE PRESENT INVENTION

1. Field of Invention

The present invention relates to a kind of transportation tool, and more particular to a universal transportation wheel kit which can be detachably mounted onto a variety of heavy objects for facilitating easy transport of those heavy objects.

2. Description of Related Arts

A conventional load carrying equipment, such as a dolly, usually comprises a main frame comprising a load carrying platform or compartment, and a wheel assembly rotatably mounted on the main frame for rotatably supporting the main frame. If a person needed to move a heavy object from one position to another, that person would probably put the heavy object onto the load carrying platform and then move the whole load carrying equipment in order to move the heavy object. By means of this, the wheel assembly substantially shares the weight of the heavy object and as a result, the person can use significant less effort to move the heavy object than when he/she moves the object merely by himself/herself.

Despite the great contribution of such conventional load carrying equipment, it possesses some inherent drawbacks that fade out some of its advantages. First, for some heavy objects, even if the user intends to use a dolly, he/she may not be able to put the object onto the load supporting platform of the dolly because of the heavy weight. One illustrative example is that when a person is trying to move a cabinet which is full of well-arranged documents from one position to another position, because of its heavy weight, he/she may decide to remove all the well-arranged documents stored inside the cabinet first and then move the empty cabinet and all the documents separately. And eventually, the person may have to find other containers or even load carrying equipments with smaller scale to carry the documents. All these troubles results from the inadequacy of conventional load carrying equipment.

Furthermore, since a load carrying equipment is of course specifically designed for carrying load, therefore it is usually made by material that possesses high material strength, such as metal. As a consequence, the load carrying equipment is usually by itself heavy and fairly expensive.

Moreover, very often, the heavy object is also very large in size, or has some extraordinary shape such as extremely long or wide. That means even if the user is somehow able to put the heavy object onto the load carrying platform, it may not be large enough to securely carry the heavy object from one position to others. After all, all load carrying platform must have a limited size and it is this inherent nature which substantially prohibits its applicability to a variety of heavy objects.

Related to the above disadvantage is that conventional load carrying equipment is sometimes too big to store. As a result, the user has to waste lots of space to store, say, just a dolly.

Finally, a lot of load carrying equipments only support, in mathematical jargon, one directional movement. Therefore, when the load carrying equipments require turning during transporting heavy objects, their users often have to manually turn the load carry equipments into a desired direction in order to, say, turn around a corner.

Nonetheless, it is worth to stress that, in order to transport a heavy object, one has to use some sorts of equipment comprising a plurality of wheels. However, one is usually difficult to simply mount a plurality of wheels onto the heavy objects in that this probably causes some sorts of damage to the objects which is highly undesirable.

### SUMMARY OF THE PRESENT INVENTION

A main object of the present invention is to provide a universal transportation wheel kit which can be mounted onto a variety of objects in a detachable manner for facilitating easy transportation of those objects without damaging the object.

Another object of the present invention is to provide a universal transportation wheel kit which can facilitate easy and convenient transportation of a variety of objects in two direction.

Another object of the present invention is to provide a universal transportation wheel kit which can substantially assist in transporting a variety of objects without requiring its user to substantially lift up those heavy object onto the transportation wheel kit of the present invention.

Another object of the present invention is to provide a universal transportation wheel kit which can be packed into a compact structure for easy storage and convenient carrying.

Another object of the present invention is to provide a universal transportation wheel kit which is simple in structure, and does not require to alter or destroy the original structure of the object in which the wheel kit of the present invention is going to transport, so as to minimize its manufacturing cost and at the same time, maximize its compatibility with as many objects as possible.

Another object of the present invention is to provide a universal transportation wheel kit which does not involve complicated mechanical mechanism in mounting the wheel kit onto a variety of objects and in transporting those objects.

Accordingly, in order to accomplish the above objects, the present invention provides a universal transportation wheel kit comprising:

a plurality of universal wheel assemblies for spacedly supporting an object to be transported thereon, wherein each of the universal wheel assemblies comprises:

a corner frame, having a L-shaped cross section, comprising a supporting base which has a first and a second adjacent outer side edge portion, and a first and second retaining walls upwardly extended from the first and a second outer side edge portions of the base respectively to define a retaining cavity within the base and the first and second retaining wall, wherein the retaining cavity is adapted for fittedly receiving and supporting a bottom corner portion of the object in a detachable manner; and

at least a wheel rotatably mounted on the corner frame for rotatably supporting and transporting the corner frame and the object; and

a connecting device securely connecting the universal wheel assemblies to define a supporting boundary within the wheel assemblies for substantially supporting and transporting the object within the supporting boundary.

### BRIEF DESCRIPTION OF THE DRAWINGS

FIG. 1 is a perspective view of a universal transportation wheel kit mounted on an object to be transported thereon according to a first preferred embodiment of the present invention.

FIG. 2 is an exploded perspective view of the universal wheel assembly according to the above first preferred embodiment of the present invention.

FIG. 3 is a perspective view of the universal transportation wheel kit which is packed in a predetermined compact structure for convenient storage.

FIG. 4 is a side view of the universal wheel assembly according to a first alternative mode of the above first preferred embodiment of the present invention.

FIG. 5 is a perspective view of the universal transportation wheel kit according to a second alternative mode of the above first preferred embodiment of the present invention.

FIG. 6 is a perspective view of the universal transportation wheel kit according to a second preferred embodiment of the present invention.

### DETAILED DESCRIPTION OF THE PREFERRED EMBODIMENT

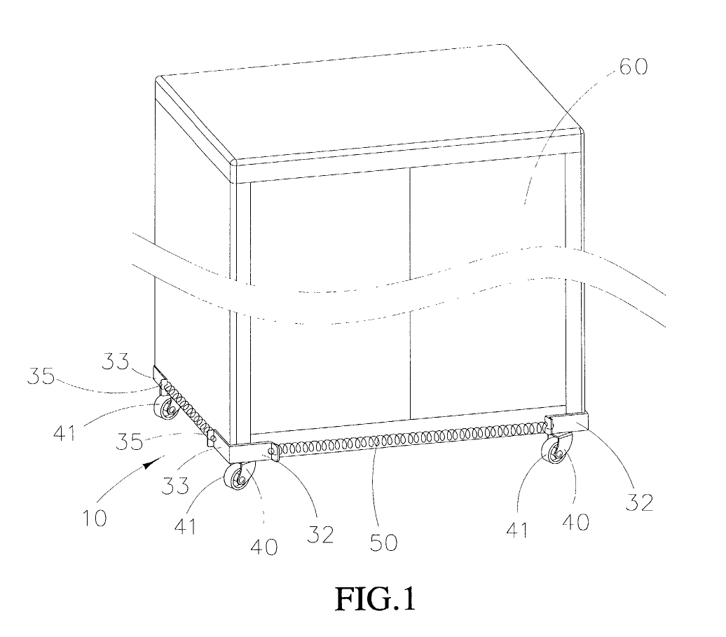

Referring to FIG. 1 of the drawings, a universal transportation wheel kit 10 according to a first preferred embodiment of the present invention is illustrated. According to the first preferred embodiment, the universal transportation wheel kit 10 comprises a plurality of universal wheel assemblies 20 adapted for mounting on an object 60 to be transported thereon, such as a cupboard as shown in FIG. 1, in a detachable manner, and a connecting device 50 for securely connecting all the universal wheel assemblies 20.

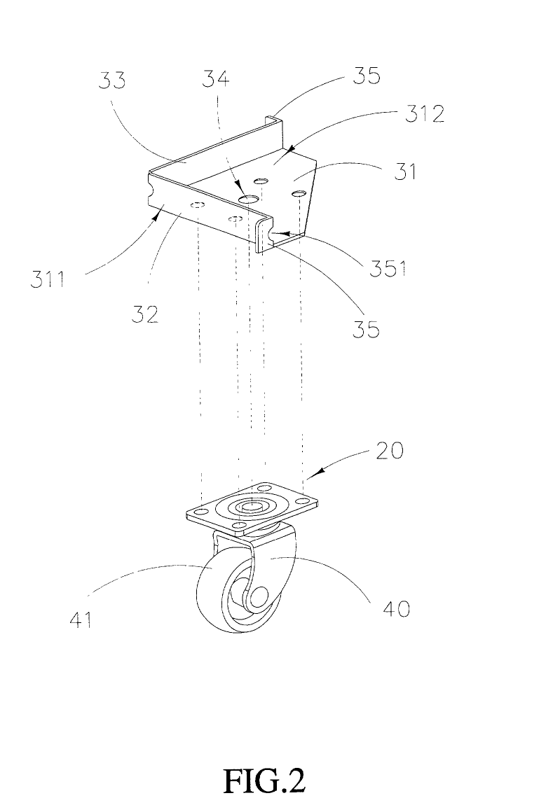

Referring to FIG. 2 of the drawings, each of the universal wheel assemblies 20 comprises a corner frame 30 which comprises a base 31 having a first and a second outer adjacent side edge portion 311, 312, a first and a second retaining walls 32, 33, upwardly and integrally extended from the first and the second side edge portion 311, 312 of the supporting base 31 respectively to define a retaining cavity 34 within the supporting base 31 and the first and the second retaining wall 32, 33 for fittedly receiving a bottom corner portion of the heavy object 60 therein.

Each of the universal wheel assemblies 20 further comprises a wheel housing 40 rotatably mounted on a bottom surface of the supporting base 31 so that it is capable of freely rotating with respect to the bottom surface of the supporting base 31, and a wheel 41 rotatably mounted inside the wheel housing 40 so that it is capable of freely rotating with respect to the wheel housing 40. Thus, the corner frame 30 is capable of moving in two dimensions on the ground. In other words, in addition of moving straightly, each of the wheel assemblies 20 is capable of turning around on the ground.

The universal transportation wheel kit 10 of the present invention is adapted for transporting a variety of objects, especially the heavy ones which cannot be moved merely by human beings without any assisting equipment, from one position to another. The plurality of universal wheel assemblies 20 are adapted for fittedly coupled with the bottom corner portions of the object so as to substantially support the object on the universal wheel assemblies 20 in a movable manner for transporting it from one position to another. In other words, as long as a particular heavy object has a plurality of bottom corner portions, it can be supported and transported by the universal transportation wheel kit 10 of the present invention.

The connecting device 50 comprises an elongated element, such as a high-strength string, connected to each of the universal wheel assemblies 20 to define a supporting boundary 51 within the universal wheel assemblies 20 for substantially supporting and transporting an object 60 disposed therewithin. Thus, according to the first preferred embodiment of the present invention, the each of the corner frames 30 comprises two affixing arms 35 outwardly extended from the first and the second retaining walls 32, 33, wherein each of the affixing arms 35 has a through affixing hole 351 formed thereon for the elongated element passing therethrough so as to connect all the universal wheel assemblies 20 all together and mount them onto the bottom portion of the object 60 in a detachable manner.

It is worth to mention that the two outwardly extended affixing arms 35 of each of the universal wheel assemblies 20 can act as a bumper for resisting collusion between the object 60 and some other external obstacles. Accordingly, when the universal wheel assemblies 20 hit some external obstacles, the external obstacles will hit the outwardly extended affixing arms 35 instead of hitting the object 60 directly so as to minimize a collusion impact to the object 60.

It should be aware that though the connecting device 50 is embodied as one elongated element connecting all the universal wheel assemblies 20, it can also be embodied as a plurality of elongated elements each jointing two of the universal wheel assemblies 20 together to achieve the same outcome, i.e. all the universal wheel assemblies 20 are jointed together and mounted to the bottom portion of the object 60.

In order to mount the universal wheel assemblies 20 onto the object 60, one has first to receive each of the bottom corner portions of the object 60 into the retaining cavity of the corner frame 30 of one universal wheel assembly 20, probably by slightly lifting up the corresponding bottom corner bottom portion of the object 60. Then, the user has to connect all the universal wheel assemblies by passing the connecting device 50 through all the affixing holes 351 of the frame corners 35. The user is then ready to move the object 60 from one position to another by means of the well-connected universal wheel assemblies 20. Once the object 60 has arrived the desire destination, the user can simply loosen the connecting device 50 and then remove all the universal wheel assemblies 20 therefrom. Thus, by lifting up only the corner portions of the object 60, the user is able to mount the universal wheel assemblies 20 thereon, instead of lifting up the whole object 60.

It is important to stress that, as an important feature of the present invention—it is universal and is capable of fitting a variety of heavy objects, by adjusting the length of the connecting device 50, the area of the supporting boundary 51 can also be adjusted so as to fit a variety of heavy objects which have different sizes and shapes. Moreover, in order to further widen the applicability of the universal transportation wheel kit 10 of the present invention, the first and the second side edge portions 311, 312 of the base 31 of each of the corner frames 30 can also be made inclined with a predetermined angle 0 to fit those objects which don't have perpendicular bottom corner portions.

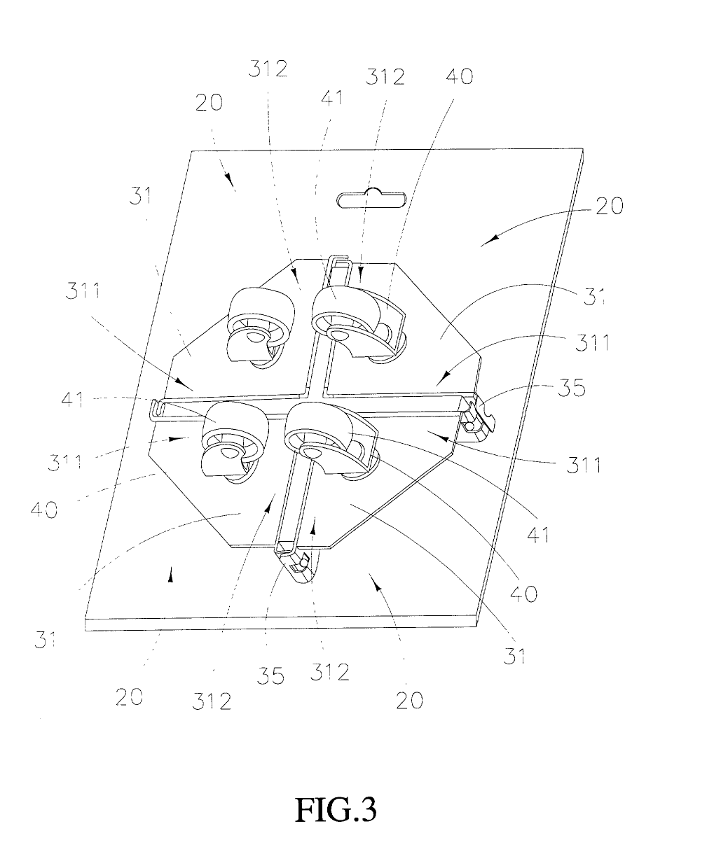

In order that the universal transportation wheel kit 10 of the present invention can be easily packed and conveniently stored, according to the first preferred embodiment, four of the universal wheel assemblies can be put side-by-side and connected together to form a storage structure as shown in FIG. 3 of the drawings, wherein in the storage structure, the affixing arms 35 of one of the universal wheel assembly 20 is positioned to overlap with the two adjacent affixing arms 35 of two adjacent universal wheel assemblies 20 respectively, such that for each pair of overlapped affixing arms 35, their respective affixing holes 351 are coincide with each other to form a through connecting hole. Accordingly, the universal transportation wheel kit 10 further comprises a plurality of locking members 70 which securely connects each pair of affixing arms 35 in a detachable manner via the through connecting hole. The locking member 70 can be any conventional connecting device, such as a bolt and a bolt nut. Alternatively, the locking member 70 can be an elastic element having a receiving cavity 23 sized and shaped to fittedly receiving each pair of affixing arms 35 so as to connect each pair of affixing arms 35 for retaining the four universal wheel assemblies 20 in their storage structure.

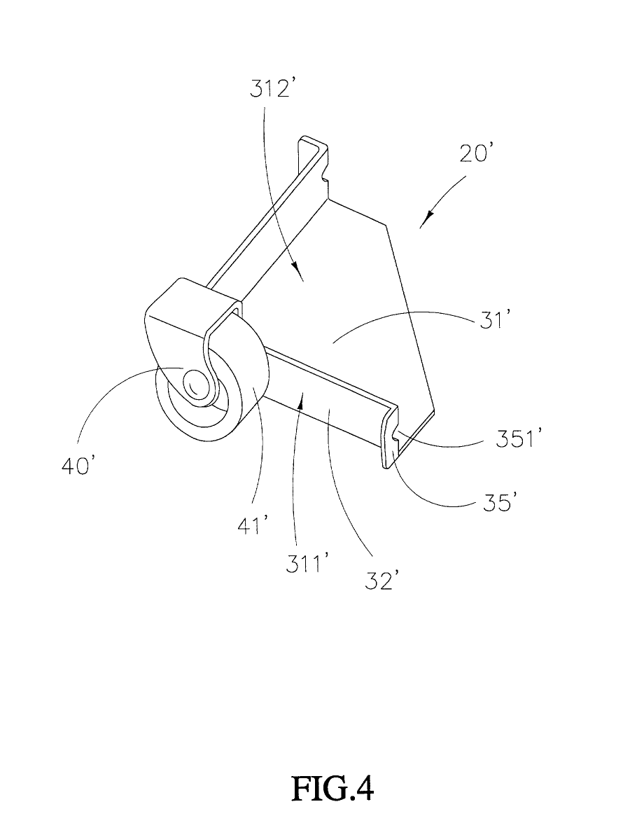

As an alternative mode according to the above first preferred embodiment of the present invention, instead of mounting wheel 41 below the supporting base 31 of each of the universal wheel assemblies 20′, the wheel 41′ of each of the universal wheel assemblies 20′ is rotatably mounted on the first retaining wall 32′, as shown in FIG. 4 of the drawings.

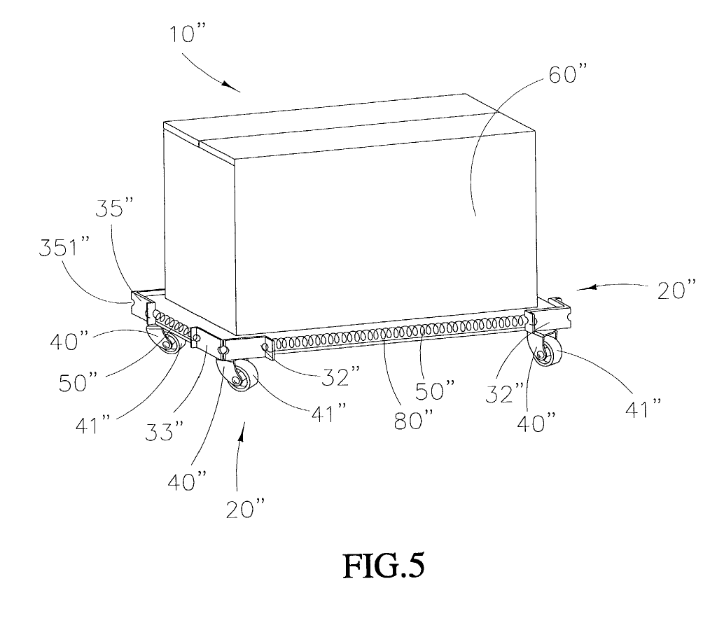

Referring to FIG. 5 of the drawings, the universal transportation wheel kit 10″ according to a second alternative mode of the above first preferred embodiment of the present invention is illustrated. According to the second alternative mode, the universal wheel assemblies 20″ can be detachably attached on a supporting platform 80″ which directly support the heavy object 60″ to be transported. This second alternative mode is mainly designed for heavy objects 60 which do not have fairly regular shape and therefore their bottom corner portions are incapable of being fittedly received inside the retaining cavity 34″ of the universal wheel assemblies 20″.

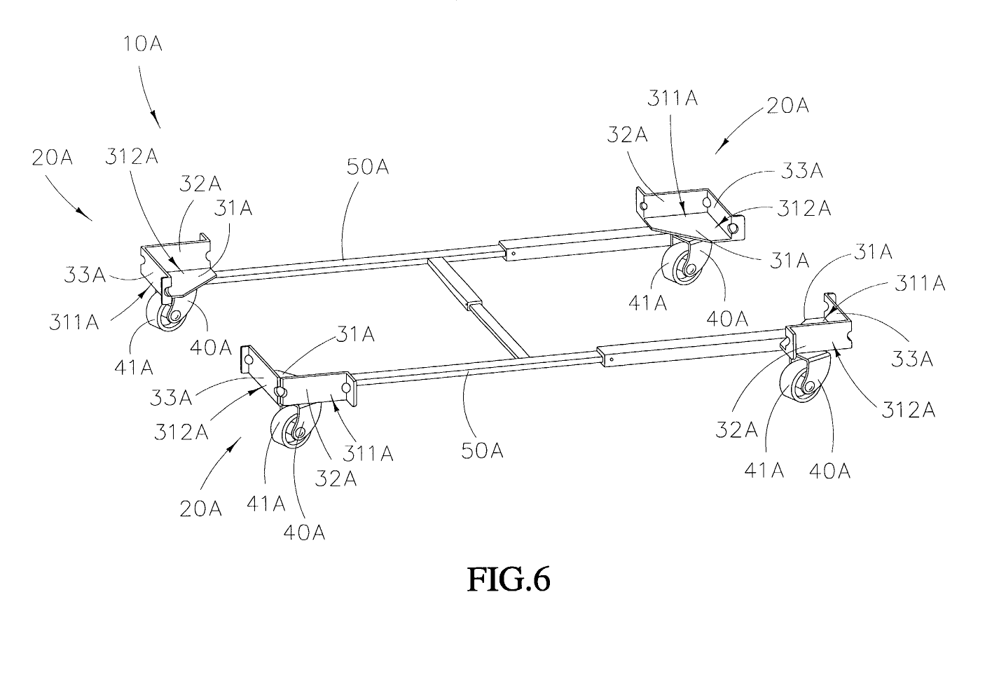

Referring to FIG. 6 of the drawings, the universal transportation wheel kit 10A according to a second preferred embodiment of the present invention is illustrated. According to the second preferred embodiment, the universal transportation wheel kit 10A comprises a first and second group of universal wheel assemblies 20A adapted for mounting on an object 60A to be transported thereon, such as a cupboard, in a detachable manner, and a connecting device 50A for securely connecting all the universal wheel assemblies 20A, wherein each group of universal wheel assemblies 20A comprises a first and a second universal wheel assembly 20A.

Similar to the above first preferred embodiment, each of the universal wheel assemblies 20A comprises a corner frame 30A which comprises a base 31A having a first and a second outer adjacent side edge portion 311A, 312A, a first and a second retaining walls 32A, 33A, upwardly and integrally extended from the first and the second side edge portion 311A, 312A of the supporting base 31A respectively to define a retaining cavity 34A within the supporting base 31A and the first and the second retaining wall 32A, 33A for fittedly receiving a bottom corner portion of the heavy object 60A therein.

Each of the universal wheel assemblies 20A further comprises a wheel housing 40A rotatably mounted on a bottom surface of the supporting base 31A in such a manner that it is capable of freely rotating with respect to the bottom surface of the supporting base 31A, and a wheel 41A rotatably mounted inside the wheel housing 40A in such a manner that it is capable of freely rotating with respect to the wheel housing 40A. Thus, the corner frame 30A is capable of moving in two dimensions on the ground. In other words, in addition of moving straightly, each of the wheel assemblies 20A is also capable of turning around on the ground, i.e. moving two-dimensionally.

The connecting device 50A comprises a first and a second elongated elements, such as a pair of metal bars, wherein the first elongated member connects two of the universal wheel assemblies 20A to form first side boundary frame, and the second elongated element connects another two of the universal wheel assemblies 20A to form second side boundary frame. The connecting device 50A further comprises at least a first jointing element 52A which connects the first and the second side boundary frame to form the supporting boundary 51A. According to the second preferred embodiment, the first jointing element 52A has one end connected to the first elongated element and another end connected to the second elongated element.

In order to enhance the flexibility of the present invention, each of the elongated elements and the jointing elements 52A can be made to have adjustable or variable length. Accordingly, each of the elongated element comprises first and second supporting segments movably connected with each other such that the length of the corresponding elongated element is capable of being adjusted so that the universal transportation wheel kit 10A of the present invention fits a variety of heavy objects 60A.

Further still, the connecting device 50A can be made detachable from the universal wheel assemblies 20A for the sake of easy and convenient storage.

Accordingly, the object 60A is disposed on the universal wheel assemblies 20A for transportation in a detachable manner, as in the case of the first preferred embodiment. Alternatively, universal wheel kit 10A can further comprises a supporting platform 80A disposed on the universal wheel assemblies 20A, and that the object 60A is disposed on the supporting platform 80A. Thus, the universal wheel assemblies 20A are arranged to transport the supporting platform 80A and the object 60A disposed thereon.

What is claimed is:

1. A universal transportation wheel kit, comprising:
a plurality of universal wheel assemblies for spacedly supporting an object to be transported thereon, wherein each of said universal wheel assemblies comprises:
a corner frame, having a L-shaped cross section, comprising a supporting base which has first and second adjacent outer side edge portions, and first and second retaining walls upwardly extended from said first and said second outer side edge portions of said base respectively to define a retaining cavity within said base and said first and said second retaining wall, wherein said retaining cavity is adapted for fittedly receiving and supporting a bottom corner portion of the object in a detachable manner; and
at least a wheel rotatably mounted on said corner frame for rotatably supporting said corner frame thereon; and
a connecting device securely connecting said universal wheel assemblies in a detachable manner to define a supporting boundary within said wheel assemblies for substantially supporting the object within said supporting boundary.

2. The universal transportation wheel kit, as recited in claim 1, wherein each of said corner frames comprises first and second affixing arms outwardly extended from said first and said second retaining walls respectively for said connecting device connecting said universal wheel assemblies therethrough.

3. The universal transportation wheel kit, as recited in claim 1, wherein each of said universal wheel assemblies further comprises a wheel housing rotatably mounted on a bottom surface of said supporting base, wherein said wheel is rotatably mounted in said wheel housing, so that each of said universal wheel assemblies are capable of moving two dimensionally.

4. The universal transportation wheel kit, as recited in claim 2, wherein each of said universal wheel assemblies further comprises a wheel housing rotatably mounted on a bottom surface of said supporting base, wherein said wheel is rotatably mounted in said wheel housing, so that each of said universal wheel assemblies are capable of moving two dimensionally.

5. The universal transportation wheel kit, as recited in claim 3, wherein said connecting device comprises an elongated element connected to each of said universal wheel assemblies to define said supporting boundary within said universal wheel assemblies, and wherein each of said affixing arms has a through affixing hole formed thereon for said elongated element passing therethrough, so as to connect said universal wheel assemblies together.

6. The universal transportation wheel kit, as recited in claim 4, wherein said connecting device comprises an elongated element connected to each of said universal wheel assemblies to define said supporting boundary within said universal wheel assemblies, and wherein each of said affixing arms has a through affixing hole formed thereon for said elongated element passing therethrough, so as to connect said universal wheel assemblies together.

7. The universal transportation wheel kit, as recited in claim 1, further comprising a supporting platform which has a plurality of corner portions fittedly received into said retaining cavities of said universal wheel assemblies respectively, so that said supporting platform is substantially supported and transported by said universal wheel assemblies, wherein said supporting platform is adapted for supporting the object thereon.

8. The universal transportation wheel kit, as recited in claim 5, further comprising a supporting platform which has a plurality of corner portions fittedly received into said retaining cavities of said universal wheel assemblies respectively, so that said supporting platform is substantially supported and transported by said universal wheel assemblies, wherein said supporting platform is adapted for supporting the object thereon.

9. The universal transportation wheel kit, as recited in claim 6, further comprising a supporting platform which has a plurality of corner portions fittedly received into said retaining cavities of said universal wheel assemblies respectively, so that said supporting platform is substantially supported and transported by said universal wheel assemblies, wherein said supporting platform is adapted for supporting the object thereon.

10. The universal transportation wheel kit, as recited in claim 7, further comprising a locking member which detachably connects said universal wheel assemblies into a storage structure, wherein in said storage structure, said first retaining wall of each of said universal wheel assemblies is positioned side-by-side with said first retaining wall of another one of said universal wheel assemblies, such that said first affixing arms of each of said universal wheel assemblies is positioned to overlap with said first affixing arms of said another universal wheel assembly, and that said affixing holes of said first affixing arms are coincide with each other to form a connecting hole for said locking member connecting said universal wheel assemblies therethrough.

11. The universal transportation wheel kit, as recited in claim 8, further comprising a locking member which detachably connects said universal wheel assemblies into a storage structure, wherein in said storage structure, said first retaining wall of each of said universal wheel assemblies is positioned side-by-side with said first retaining wall of another one of said universal wheel assemblies, such that said first affixing arms of each of said universal wheel assemblies is positioned to overlap with said first affixing arms of said another universal wheel assembly, and that said affixing holes of said first affixing arms are coincide with each other to form a connecting hole for said locking member connecting said universal wheel assemblies therethrough.

12. The universal transportation wheel kit, as recited in claim 9, further comprising a locking member which detachably connects said universal wheel assemblies into a storage structure, wherein in said storage structure, said first retaining wall of each of said universal wheel assemblies is positioned side-by-side with said first retaining wall of another one of said universal wheel assemblies, such that said first affixing arms of each of said universal wheel assemblies is positioned to overlap with said first affixing arms of said another universal wheel assembly, and that said affixing holes of said first affixing arms are coincide with each other to form a connecting hole for said locking member connecting said universal wheel assemblies therethrough.

13. The universal transportation wheel kit, as recited in claim 2, wherein for each of said universal wheel assemblies, said wheel is rotatably mounted on said first retaining wall.

14. The universal transportation wheel kit, as recited in claim 13, wherein said connecting device comprises an elongated element connected to each of said universal wheel assemblies to define said supporting boundary within said universal wheel assemblies, and wherein each of said affixing arms has a through affixing hole formed thereon for said elongated element passing therethrough, so as to connect said universal wheel assemblies together.

15. The universal transportation wheel kit, as recited in claim 13, further comprising a supporting platform which has a plurality of corner portions fittedly received into said retaining cavities of said universal wheel assemblies respectively, so that said supporting platform is substantially supported and transported by said universal wheel assemblies, wherein said supporting platform is adapted for supporting the object thereon.

16. The universal transportation wheel kit, as recited in claim 14, further comprising a supporting platform which has a plurality of corner portions fittedly received into said retaining cavities of said universal wheel assemblies respectively, so that said supporting platform is substantially supported and transported by said universal wheel assemblies, wherein said supporting platform is adapted for supporting the object thereon.

17. The universal transportation wheel kit, as recited in claim 1, wherein said connecting device comprises first and second elongated elements and at least one jointing element, wherein said first elongated element connects two of said universal wheel assemblies to form a first side boundary frame, and said second elongated element connects another said two universal wheel assemblies to form a second side boundary frame, said jointing element connecting said first and said second side boundary frame to define said supporting frame, each of said elongated elements comprising first and second supporting segments movably connected with each other such that a length of each of said elongated elements is capable of being adjusted.

18. The universal transportation wheel kit, as recited in claim 17, wherein each of said elongated elements and said jointing element comprise a first and a second supporting segment movably connected with each other such that lengths of each of said elongated elements and said jointing element are capable of being adjusted.

19. The universal transportation wheel kit, as recited in claim 18, wherein each of said universal wheel assemblies further comprises a wheel housing rotatably mounted on a bottom surface of said supporting base, wherein said wheel is rotatably mounted in said wheel housing, so that each of said universal wheel assemblies are capable of moving two dimensionally.

20. The universal transportation wheel kit, as recited in claim 19, further comprising a supporting platform which has a plurality of corner portions fittedly received into said retaining cavities of said universal wheel assemblies respectively, so that said supporting platform is substantially supported and transported by said universal wheel assemblies, wherein said supporting platform is adapted for supporting the object thereon.
